(19) United States
(12) Patent Application Publication
(10) Pub. No.: US 2025/0299048 A1
(43) Pub. Date: Sep. 25, 2025

(54) AUTOMATED OPTIMIZATION OF EXTRACTION-BASED CATEGORIZATION PROCESSES

(71) Applicant: INTUIT INC., Mountain View, CA (US)

(72) Inventors: Yair HORESH, Kfar-Saba (IL); Aleksandr KIM, Tel Aviv (IL)

(21) Appl. No.: 18/612,138

(22) Filed: Mar. 21, 2024

(51) Int. Cl. G06N 3/09; G06F 16/23

(52) U.S. Cl. CPC G06N 3/09; G06F 16/2379

(57) ABSTRACT

Aspects of the present disclosure relate to automated transaction categorization. Embodiments include receiving data associated with transactions involving multiple users and an entity; extracting fields from the data by creating an embedding representation of the data; processing the extracted fields through multiple layers of a trained neural network model to assign a class to the fields; generating candidate mappings for the transactions by applying multiple sets of mapping rules to the extracted fields; generating a score for each candidate mapping by applying scoring rules to the candidate mappings; selecting a set of mapping rules for categorizing transactions involving the entity based on the generated score for a corresponding candidate mapping of the candidate mappings; and creating mappings of transactions associated with a particular user based on applying the selected set of mapping rules to each transaction associated with the particular user and the entity.

### INTRODUCTION

Aspects of the present disclosure relate to techniques for automated transaction categorization. In particular, techniques described herein involve using a machine learning model to classify fields extracted from transaction data, determining mapping rules for categorizing transactions associated with a particular entity, and using the determined mapping rules to map transactions between users and the entity based on the classified fields.

### BACKGROUND

Every year, millions of people, businesses, and organizations around the world utilize software applications for tracking and processing transactions. For example, an individual may complete a transaction online via a website, and a software application may record data associated with the transaction.

A software application that records such data may allow users of the application to keep track of their transaction history in order to manage their finances. However, different entities have different formats and conventions for transactions and their associated data. For instance, one entity may label transactions in which funds passed from the entity to a user as a transaction with a negative value (i.e., if the organization deposited $500 into the account of the user, the transaction may be labeled as “−500”). Another entity may label transactions in which funds passed from the entity to a user as either a debit transaction or a credit with a positive value (i.e., if the organization deposited $500 into the account of the user, the transaction may be labeled as “debit: 500” or “credit: 500”). These inconsistencies make it impossible for existing transaction categorization technologies to accurately categorize transactions automatically for large groups of users. For example, a transaction categorization system may be required to categorize millions of transactions each day between users and a constantly growing multitude of entities such as banks, retailers, service providers, etc., each with inconsistent formats for transaction data. Furthermore, entities may frequently change the format for their transaction data, and/or have different formats for different types of transactions. As a result, conventional techniques for automatically categorizing transactions fail to accurately categorize transactions for large groups of users. For instance, using conventional supervised learning techniques to train a machine learning model to categorize transactions involving an entity is not a practical solution because such techniques require labeling a training data set for each provider and training a machine learning model based on the labeled training data. Labeling such data for thousands of entities requires a significant amount of manual labor, user feedback, data processing, and/or computational overhead. Additionally, the frequent and unpredictable changes that entities make to their transaction data formatting may only be detected when users notice errors in transaction categorizations (e.g., a machine learning model trained to categorize data based on the old format will fail to accurately categorize data of the new format). Also, for newer entities such as entities for which a categorization system lacks historical transaction data, there may be no data available for use as training data.

Thus, there is a need in the art for improved techniques of automated transaction categorization.

### BRIEF SUMMARY

Certain embodiments provide a method of automated transaction categorization. The method generally includes: receiving electronic transaction data associated with transactions involving multiple users and an entity; extracting fields from the electronic transaction data; assigning a respective class of a set of classes to each respective extracted field of the extracted fields using a machine learning model trained through a supervised learning process to assign classes to input fields; generating candidate mappings for the transactions based on applying multiple sets of mapping rules to the extracted fields; generating a score for each candidate mapping of the candidate mappings based on applying scoring rules to the candidate mappings; selecting a set of mapping rules from the multiple sets of mapping rules for categorizing transactions involving the entity based on the generated score for a corresponding candidate mapping of the candidate mappings; and creating mappings of transactions associated with a particular user based on applying the selected set of mapping rules to each transaction associated with the particular user and the entity.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated transaction categorization.

FIG. 2 depicts a sequence diagram for an automated transaction categorization system.

FIG. 3 depicts an example of transaction data that may be automatically categorized.

FIG. 4 depicts example operations related to automated transaction categorization.

FIG. 5 depicts an example of a processing system for automated transaction categorization.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automated transaction categorization.

According to certain embodiments, a machine learning model is used to assign classes to fields extracted from transaction data for an entity, mapping rules are used to automatically generate candidate mappings for the classified fields, the candidate mappings are automatically scored using scoring rules, and then the mapping rules that were used to produce the mapping that achieved the highest score are selected for applying to other transactions involving the entity. In some cases, the mapping rule selection process may be repeated if scores (e.g., determined using the scoring rules) for other transactions that are mapped using the mapping rules that were selected fail to meet a threshold, such as over a period of time.

In some embodiments, electronic transaction data associated with transactions involving multiple users and an entity may be received. An entity may be, for example, a financial institution such as a bank, a retail seller of goods, a service provider, and/or the like. The transaction data may be, for example, transaction data that is recorded or otherwise obtained by a software application associated with a user's computing device. For example, the user may engage in an online transaction, and the software application may record the data associated with that transaction. In other embodiments, the transaction data includes transaction records that were imported to a software application, such as by uploading, downloading, entering, scanning, taking a picture, and/or otherwise providing the transaction records to the software application.

Transactions involving different entities may be recorded. For example, the software application may record or otherwise obtain records of transactions between a user and the various entities with which the user engages in transactions, such as banks, retail sellers of goods, service providers, etc.

In certain embodiments, the transaction data is stored by the automated transaction categorization system. The stored transaction data may be stored in a tabular form. For example, a label associated with a field may be used as the header of a column and a value associated with the field may be inserted as a value within the column. Fields are generally present within transaction data, and may include data associated with labels. For example, transaction data may include a field that states how much money was exchanged in the transaction. This field may include a numerical value and a label, such as “amount.” Other examples of fields include fields that list the date of the transaction, fields that list the names of the parties to the transaction, and fields that otherwise describe the transaction.

Certain embodiments provide that fields may be extracted from the electronic transaction data. This extraction may be achieved by any method of electronic text-based data extraction, such as optical character recognition (OCR) or using a machine learning model that is trained to extract fields through techniques such as embedding-based extraction.

According to some embodiments, a class may be assigned to each extracted field. Field classes may include an amount class, a date class, a description class, and an “other” class. The amount class may include fields that list the amount of money exchanged during a transaction, such as the amount fields discussed above. The date class may include fields that list the date on which the transaction occurred, such as the date fields discussed above. The description class may include fields that describe the transaction. For example, fields corresponding to the description class may include fields that indicate the purpose of the transaction, such as an indication that the transaction was a rent payment or a sale of goods. The “other” class may be used to classify fields that do not fall within any other classification, such as fields that fail to reach a threshold of confidence for any other class. For example, a field that lists a customer's identification number, a field that contains metadata associated with a software application, and an empty field are potential examples of fields that may be classified as “other.” The classification may be performed by a machine learning model that is trained to classify fields. For example, the machine learning model may be trained through a supervised learning process to classify the fields. The training data used in the supervised learning process may be fields that have been manually classified. Supervised machine learning techniques may be used for field classification because field classes are consistently recognizable across various formats of transaction data. For example, while different entities may have different conventions for representing amount values (e.g., positive/negative, debit/credit), amount fields may generally be recognized as amount fields regardless of convention (e.g., the machine learning model can recognize that “−500” and “debit: 500” are both amount fields even if the machine learning model cannot determine whether the amount values should be represented as positive or negative with respect to other values within a standardized database).

Certain embodiments provide that candidate mappings are generated for the transactions based on applying multiple sets of mapping rules to the extracted fields. The candidate mappings may be generated for a set of transactions involving users and a particular entity. Mapping rules generally refer to rules that are used to process extracted fields in order to categorize transactions. For example, a mapping rule may indicate that a particular class of fields is to be processed in a particular way, and the transaction categorization system may process a field corresponding to the particular class in the particular way based on the mapping rule. A candidate mapping generally refers to the result of applying a particular set of mapping rules to a field.

In some embodiments, mapping rules for amount fields determine whether the value contained within the amount field should be represented as positive or negative relative to amounts associated with other categorized transactions. For instance, a mapping rule may require that the amount is determined to be either positive or negative based on the absence or presence of a negative sign in front of the amount. Based on this mapping rule, the transaction categorization system may determine that an amount should be represented as negative (i.e., as a “debit” transaction relative to the user from whom the transaction record is received) if the amount field contains a negative sign. Alternatively, the transaction categorization system may determine that the amount should be represented as positive (i.e., as a “credit” transaction relative to the user from whom the transaction record is received) if the amount field does not contain a negative sign.

Another mapping rule may require representing amounts as positive if a negative sign is present, and negative if there is no negative sign. For example, such representation of amount field values may be necessary if the values are represented relative to the entity in the transaction data, and it is desired to represent the values relative to the user in the categorized transaction (e.g., a negative transaction for an entity may be a positive transaction for a user and the amount of the transaction may be represented as positive relative to the user's other transactions). As another example, a mapping rule may require that an amount be represented as positive if a word such as “credit” or “deposit” appears next to the amount field, and negative if a word such as “debit” or “withdrawal” appears next to the amount field (or vice versa, depending on the desired point of reference).

Certain embodiments provide that mapping rules are applied to date fields to generate candidate mappings of dates. For example, a given date mapping rule may specify that the first digit or pair of digits in a date is a month, the middle digit or pair of digits is a day within the month, and the last digit or set of digits is a year. For example, applying this mapping rule may result in the transaction categorization system interpreting “05/01/23” as May 1, 2023. Other mapping rules may result in mappings that interpret this date field value as Jan. 5, 2023 (e.g., an alternative mapping rule may specify that the first digit or pair of digits is a day within a month, and so on).

According to certain embodiments, mapping rules are used for description fields. For example, a mapping rule may indicate that fields classified as description fields are to be concatenated, thus creating a single description of the transaction from multiple description fields.

Some embodiments provide that each candidate mapping is scored based on applying scoring rules to the candidate mapping. Scoring rules may be chosen for mappings involving an entity based on the type of the entity. The type of the entity may be determined based on an indication to the type in the transaction data, provided by a user, or otherwise provided to or determined by the transaction categorization system. For example, if the indication indicates that the entity is a service provider, such as a provider that charges users monthly fees for a service, service provider scoring rules may be applied to the candidate mappings. A service provider scoring rule may give a candidate mapping a low score if most of the mapped transactions indicate that money was transferred from the service provider to the user. By contrast, a service provider scoring rule may give a candidate mapping a high score if most of the mapped transactions indicate that money was transferred from the user to the service provider. This is because, in transactions between users and service providers, funds are normally transferred from the user to the service provider. In addition to scoring rules based on the proportion of positive transactions to negative transactions, scoring rules for mappings of amount fields may be based on other attributes as well. For example, scoring rules may score mappings based on the size of the amount of the transaction (e.g., if transactions involving an entity typically involve over one hundred dollars, a scoring rule may result in a high score if most of the transactions are over one hundred dollars). High scores may indicate that a mapping is correct, whereas low scores may indicate an error in the mapping, and that processes such as extraction, classification, and/or mapping should be repeated. In some embodiments, low scores may indicate that different mapping rules should be selected.

In some embodiments, scoring rules score mappings of dates. For example, applying a particular date mapping rule may result in a nonsensical date mapping (e.g., the mapping rule may indicate that the first pair of digits in a date is to be interpreted as the month, resulting in 27/03/23 being interpreted as a transaction that occurred in the twenty-seventh month). The score for a nonsensical mapping map be low, indicating that the mapping is incorrect, such as based on a scoring rule indicating that low scores are to be assigned to date mappings that result in a month greater than twelve, a day of the month greater than 31 (or 28, 29, or 30, depending on the month and/or whether the year is a leap year), and/or the like.

Certain embodiments provide that scoring rules are applied to description mappings. For example, if the description matches patterns for descriptions that exist in transactions involving other providers, the score may be high.

According to some embodiments, after candidate mappings for transactions involving users and an entity are scored, the mapping rules that resulted in the mapping with the highest score are selected for categorizing transactions involving the entity. For example, a set of transactions involving the entity and multiple users may be chosen (e.g., randomly, sequentially, and/or based on some other condition) for generating candidate mappings. The mapping rules that result in the mapping(s) with the highest score(s) (e.g., for one or more transactions, on average across multiple transactions, and/or the like) may be used to categorize other transactions involving that entity. Thus, when a user engages in a transaction with the entity, the transaction may be automatically categorized using the chosen mapping rules.

Certain embodiments provide that transaction categorizations made using the chosen mapping rules are scored using the scoring rules. For example, once a set of mapping rules are chosen for an entity, transactions that users make involving the entity may be categorized using the mapping rules, as described above. If these categorizations fail to meet a threshold score (or if a threshold number of these categorizations fail to meet the threshold score), a new set of mapping rules may be chosen. The new set of mapping rules may be chosen, for example, by choosing the mapping rules that produced the next highest score during the mapping process. As another example, the new set of mapping rules may be chosen based on repeating parts of the process for determining mapping rules (e.g., extraction, classification, mapping, and/or scoring). Scoring categorizations that are made by applying the chosen mapping rules over time may allow the transaction categorization system to detect changes that entities make to their transaction data formatting and automatically correct the categorization system based on the changes. For example, if an entity changes the entity's formatting for transaction data, categorizations made using a previously chosen set of mapping rules for the entity may be incorrect, and may therefore result in a low score when the scoring rules are applied. Based on this low score, a new set of mapping rules may be chosen for the entity.

Embodiments of the present disclosure provide numerous technical and practical effects and benefits. For instance, teachings of the present disclosure allow for the automatic and approximately instantaneous categorization of transactions based on transaction data, a task that cannot be practically performed in the human mind. Also, while existing techniques such as supervised machine learning-based categorization may be used for automated categorization of transactions, such techniques lead to inaccurate categorizations involving new entities, entities that change their transaction data formats, and other entities for which up-to-date training data is not available. By contrast, embodiments of the present disclosure allow for automatically categorizing transactions without the need for labeling a comprehensive training data set for each entity or keeping such a labeled training data set up to date as circumstances change, such as when entities change their transaction data formats or new entities enter into transactions. Additionally, as described above, teachings of the present disclosure provide for a transaction categorization system that automatically detects changes in entity data formatting and updates itself in response (i.e., by scoring transactions that are categorized using the chosen mapping rules for that entity and choosing new mapping rules in response to a low score). By contrast, existing techniques require receiving feedback (e.g., feedback from users who identify incorrectly categorized transactions) and/or producing updated training data sets in order to detect and account for changes that entities make to transaction data formatting. Thus, teachings of the present disclosure result in improved functionality for transaction categorization systems.

### Example Components Related to Automated Transaction Categorization

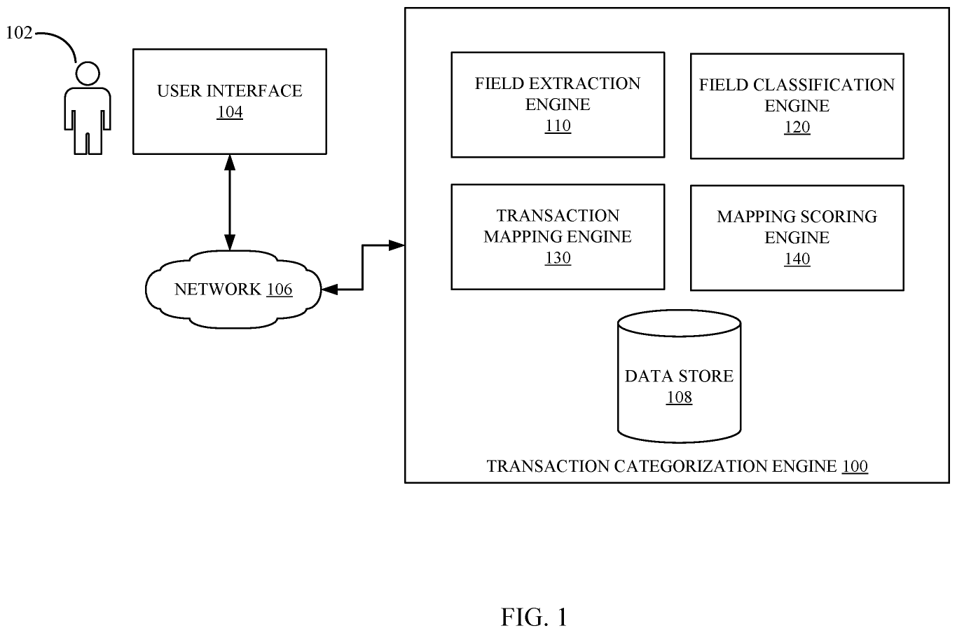

FIG. 1 is an illustration of example computing components related to automated transaction categorization.

A user 102 may interact with a user interface 104. User interface 104 may correspond to a computing device that allows user 102 to conduct online transactions with various entities and/or to perform management of transactions, such as categorization of transactions that may have been performed separately from user interface 104. Transaction data associated with these transactions may be sent to transaction categorization engine 100 over a network 106, and transaction categorization engine 100 may send transaction categorizations to user interface 104 over the network.

Transaction categorization engine 100 may comprise field extraction engine 110. Field extraction engine 110 may comprise one or more processors configured to extract fields from transaction data. Field extraction engine 110 may be configured to use any method of electronic text-based data extraction, such as optical character recognition (OCR). In some embodiments, field extraction engine 110 comprises a machine learning model that is trained to extract fields through techniques such as embedding-based extraction. An embedding generally refers to a vector representation of data that represents the data as a vector in n-dimensional space such that similar data items are represented by vectors that are close to one another in the n-dimensional space. Embeddings may be generated through the use of an embedding model, such as a neural network or other type of machine learning model that learns a representation (embedding) for data through a training process that trains the neural network based on a data set, such as a plurality of features of a plurality of data items.

Transaction categorization engine 100 may comprise field classification engine 120. Field classification engine 120 may comprise one or more processors that are configured to assign classes to extracted fields. In certain embodiments, field classification engine 120 comprises a machine learning model that is trained through a supervised learning process to classify the fields. The training data used in the supervised learning process may be fields that have been manually classified. Supervised learning generally involves providing training inputs as inputs to a machine learning model. The machine learning model processes the training inputs and generates outputs based on the training inputs. The outputs are compared to known labels associated with the training inputs (e.g., ground truth labels based on historical data that is manually produced or verified) to determine the accuracy of the machine learning model, and parameters of the machine learning model are iteratively adjusted until one or more conditions are met. For instance, the one or more conditions may relate to an objective function (e.g., a cost function or loss function) for optimizing one or more variables (e.g., model accuracy). In some embodiments, the conditions may relate to whether the outputs produced by the machine learning model based on the training inputs match the known labels associated with the training inputs or whether a measure of error between training iterations is not decreasing or not decreasing more than a threshold amount. The conditions may also include whether a training iteration limit has been reached. Parameters adjusted during training may include, for example, hyperparameters, values related to numbers of iterations, weights, functions used by nodes to calculate scores, and the like. In some embodiments, validation and testing are also performed for a machine learning model, such as based on validation data and test data, as is known in the art. In some embodiments, a machine learning model of field classification engine 120 may be retrained in response to classifications that were identified as incorrect. According to certain embodiments, the machine learning model is a neural network model. Neural network models generally include a plurality of connected units or nodes, which may also be referred to as artificial neurons. Each node generally has one or more inputs with associated weights, a net input function, and an activation function. Nodes are generally included in a plurality of connected layers, where nodes of one layer are connected to nodes of another layer, with various parameters governing the relationships between nodes and layers and the operation of the neural network.

Transaction categorization engine 100 may comprise transaction mapping engine 130. Transaction mapping engine 130 may comprise one or more processors that are configured to generate candidate mappings by applying multiple sets of mapping rules to transaction data. Each candidate mapping may correspond to a set of mapping rules used to generate the candidate mapping.

Transaction categorization engine 100 may comprise mapping scoring engine 140. Mapping scoring engine 140 may comprise one or more processors that are configured to score categorizations and candidate mappings based on a set of scoring rules. The set of scoring rules used to score mappings and categorizations involving a particular entity may be based on the type of the particular entity (e.g., categorizations for transactions involving an investment bank may be scored using a set of scoring rules that are designed for investment banks). In some cases, the scoring rules associated with a given entity may be updated over time if the scoring rules are determined to be inaccurate, such as based on manual review and/or the scoring rules being used to select mapping rules that produce incorrect results.

Transaction categorization engine 100 may comprise a data store 108 for storing transaction data. Data store 108 may, for example, be a database, repository, or other data storage entity in which transaction data may be stored.

### Sequence Diagram for an Automated Transaction Categorization System

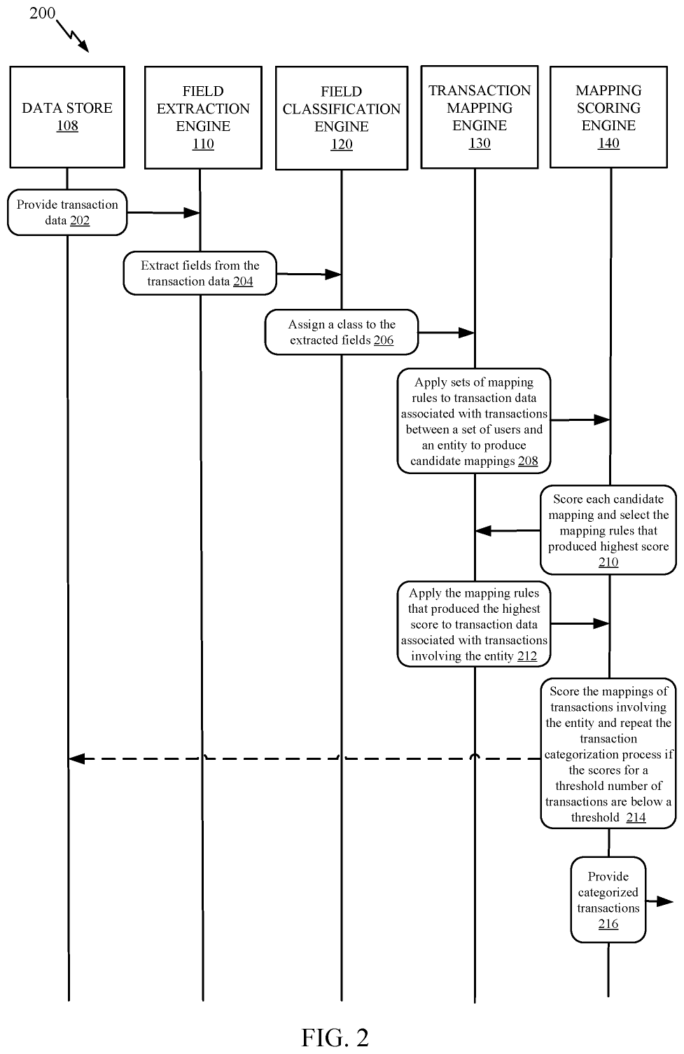

FIG. 2 illustrates a sequence diagram 200 for an automated transaction categorization system according to some embodiments of the present disclosure. Sequence diagram 200 includes data store 108, field extraction engine 110, field classification engine 120, transaction mapping engine 130, and mapping scoring engine 140 of FIG. 1.

At 202, data store 108 provides transaction data to field extraction engine 110. The transaction data may consist of records of multiple transactions, each transaction involving an individual and an entity. Transaction data for multiple entities may be provided. For example, transaction data associated with transactions between an entity and the entity's customers may be provided in order to select a set of mapping rules for the entity, as described in further detail below at 208. As another example, transaction data associated with transactions between a user and different entities with which the user does business may be provided in order to generate categorizations for the transactions and provide the categorizations to the user, as discussed below with respect to 216.

At 204, fields are extracted from the transaction data by field extraction engine 110 and provided to field classification engine 120. Field extraction engine 110 may extract fields from the transaction data using text extraction techniques such as those described above with respect to FIG. 1.

At 206, field classification engine 120 assigns a class to the extracted fields and provides the extracted fields to transaction mapping engine 130. Field classification engine may be a machine learning model that is trained through a supervised learning process to assign classes to extracted fields, as described above with respect to FIG. 1. Field classes may include an amount class, a date class, a description class, an “other,” or miscellaneous, class, and/or the like.

Fields assigned to the amount class may include fields that describe the amount of money exchanged in the transaction and how the money was exchanged (e.g., from one party to another, or vice versa). Fields classified as amount fields may include words such as “debit,” “credit,” “deposit,” “withdrawal,” or other similar words that are used to indicate the direction of the transaction (i.e., whether an entity sent money to a user or received money from a user). Fields classified as amount fields may include numbers that represent the value of money exchanged in the transaction (e.g., transaction data for a transaction of twenty dollars may include a field that contains the number “20.” Amount fields may also include a positive or a negative sign (e.g., “+” or “−”) that indicates the direction of the transaction. Numbers that indicate the value of the transaction and words or signs that indicate the direction of the transaction may appear in the same field, or they may appear in separate fields. If the field indicating the direction of the transaction and the field indicating the value of the transaction are separate fields, classification engine 120 may classify each field as an amount field. The multiple amount fields may be concatenated or otherwise processed so that the transaction mapping engine 130 can generate an accurate mapping of the amount field.

Fields assigned to the description class may include fields that describe the transaction. For example, a description may include the name of an item that was purchased or a brief written description of a transaction such as a description provided by the entity or the user when the transaction occurred. In some cases, a field assigned to a description class includes the name of the entity (e.g., the counterparty to the transaction). Fields assigned to the date class may include fields that indicate the date on which a transaction occurred. Fields assigned to the “other” class may include fields for which the field classification engine 120 was unable to assign a class. For example, field classification engine 120 may generate predictions as to which class a field belongs, and the predictions for the fields relative to the amount, date, and description fields may fail to meet a classification threshold. Examples of such fields that may be classified into the “other” class may include fields that contain user identifiers, software application metadata unrelated to the transaction itself, and/or the like.

At 208, transaction mapping engine 130 applies sets of mapping rules to transaction data associated with transactions between a set of users and an entity to produce candidate mappings for the entity. A mapping rule is generally a rule that is used to process extracted fields in order to categorize transactions. For example, a first candidate mapping of the transactions may be created based on applying a first mapping rule to all of the transactions, a second candidate mapping of the transactions may be created based on applying a second mapping rule to all of the transactions, etc. The transaction data used to generate candidate mappings for the entity may be selected randomly (or based on one or more conditions) from transaction data involving the entity such that the transaction data includes transactions involving a cross-section of users who engaged in transactions with the entity.

Mapping rules for amount fields may include rules for determining the direction of a transaction. In one example, a mapping rule may require negating the amount of the transaction based on the data associated with that transaction containing a word such as “debit” or “deposit.” In another example, a different mapping rule may require negating the amount of the transaction based on the data associated with that transaction containing a word such as “credit” or “withdrawal.” As another example, another mapping rule may require negating the amount of the transaction based on the presence or absence of a negative sign. Transaction mapping engine 130 generates candidate mappings by applying these mapping rules (e.g., by negating amount values based on the presence or absence of certain words or signs according to the rules).

Mapping rules for date fields may also be applied to generate candidate mappings for dates. In one example, a mapping rule may require that the first digit or set of digits in a date field represent the month in which a transaction occurred, the second digit or set of digits in a date field represent the day of the month on which a transaction occurred, and the third set of digits in a date field represent the year in which a transaction occurred (e.g., MM/DD/YYYY). In a different example, a mapping rule may require that the first digit or set of digits in a date field represent the day of the month on which a transaction occurred, the second digit or set of digits in a date field represent the month in which a transaction occurred, and the third set of digits in a date field represent the year in which a transaction occurred (e.g., DD/MM/YYYY). In another example, a mapping rule may require that the last set of digits have “20” concatenated to the front of the set (e.g., such that 12/25/23 is interpreted as Dec. 25, 2023 instead of December 25, 23 A.D.). Mapping rules may also be applied to descriptions. For example, a mapping rule may require that multiple description fields be concatenated into a single description field.

At 210, mapping scoring engine 140 scores each of the candidate mappings and chooses the mapping rules that resulted in the highest score as the mapping rules for categorizing transactions involving the entity. The scoring rules for scoring the candidate mappings may be chosen based on the type of the entity. The type of the entity may be indicated in the transaction data, a user may provide an indication of the type of the entity (e.g., by answering a prompt that asked the user to describe the type of the entity), or another indication of the type of the entity may be provided.

Scoring rules may be based on the proportion of categorized transactions that are positive compared to the proportion that are negative. In one example, a scoring rule for transactions involving a service provider may result in a lower score for a mapping if a large proportion (e.g., more than a threshold percentage) of the transactions are positive relative to the user (i.e., indicating that money went from the entity to the user). The same scoring rule may result in a higher score for a mapping if a large proportion (e.g., more than a threshold percentage) of the transactions are negative relative to the user (i.e., indicating that money went from the user to the entity, as is typical for transactions involving service providers). In another example, scoring rules for certain banking accounts may result in a lower score if too few transactions are negative relative to the user, or if too few transactions are positive relative to the user, since funds are typically withdrawn from or deposited into certain banking accounts.

Scoring rules may be based on the size of the amount of the transactions. For example, certain types of entities may typically deal with smaller transactions, whereas other types of entities may typically deal with larger transactions. If a mapping results in categorizations that include large amount values for an entity that typically deals with small transactions, applying the scoring rules for an entity that typically deals with small transactions may result in a low score. For instance, such mappings may indicate an error in field extraction or categorization (e.g., too many digits or not enough digits were extracted for an amount, or a field such as a date field was classified as an amount field).

Scoring rules may also score description mappings. For example, if a description is inconsistent with descriptions for similar types of entities (e.g., based on description embeddings, patterns, and/or the like), the score for the description mapping may be lower than it would otherwise be if the description were consistent with descriptions for similar types of entities.

Once mapping scoring engine 140 scores each of the candidate mappings, the mapping rules that resulted in the candidate mapping with the highest score are chosen for mapping transactions involving the entity. At 212, transaction mapping engine 120 applies the chosen set of mapping rules to transactions involving the entity. For example, a particular user may engage in multiple transactions, each transaction involving a different entity. For the transactions involving each entity, transaction mapping engine 120 may apply mapping rules chosen for that entity. Based on applying the chosen mapping rules, categorizations may be generated for each of the user's transactions.

At 214, mapping scoring engine 140 scores (e.g., using the applicable scoring rules) the transactions that are categorized using the selected mapping rules. If the score for the categorizations indicates an error in the mappings (e.g., if a threshold number of transaction categorizations for a given entity fail to meet a threshold score) then one or more steps of the transaction categorization process and/or mapping rule selection process may be repeated for the entity. For example, low scores may be the result of errors in extraction, classification, and/or mapping.

At 216, if the score for the transaction categorizations indicates that the categorization process was successful, the categorized transactions may be provided to the user, such as for review and approval. For instance, the user may approve of the automatic transaction categorizations and/or may provide feedback indicating that one or more of the automatic categorizations is incorrect. Accurate amounts, dates, and descriptions allow users to track their transaction history. User feedback may be used to adjust one or more aspects of the process, such as re-training one or more machine learning models, repeating the mapping rule selection process, adjusting one or more scoring rules, and/or the like.

### Example of Transaction Data That May Be Automatically Categorized

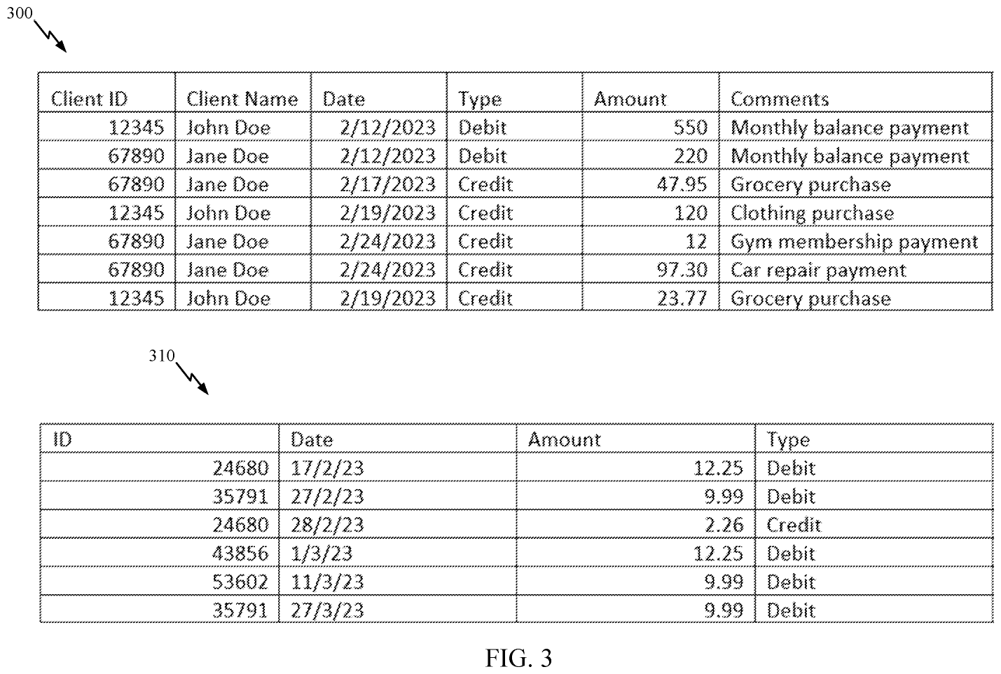

FIG. 3 depicts an example of transaction data that may be automatically categorized.

Transaction data 300 illustrates an example related to transaction data for transactions involving a credit card provider and two clients. This transaction data may be illustrative of a random sampling of data involving the credit card provider that is used to generate candidate mappings for the credit card provider. Clients John Doe and Jane Doe each made a monthly balance payment and, and each client also made various purchases with their credit cards. The field extraction engine may extract the various fields of this transaction data. The field classification engine may assign each of the fields a class. For example, the “type” fields (debit/credit) and the “amount” field may be assigned to the amount class. The “date” field may be assigned to the date class. The “comments” field may be assigned the description class. The “client name” and “client ID” fields may be assigned to the “other” class because these fields do not correspond to any of the three main classes.

Mapping rules may be applied to each of the classified fields in 300. A set of mapping rules that negates the amount value relative to the user based on the word “credit” appearing in the data associated with a transaction may generate a correct mapping for transactions associated with this bank. This is because, for the entity in example 300, the word “credit” is used to denote transactions where the user increases the balance that the user owes on the account, whereas the word “debit” is used to denote transactions where the user decreases the balance that the user owes on the account. A second mapping rule may generate an incorrect mapping by negating the amount value relative to the user based on the word “debit” appearing in the data associated with a transaction.

Mapping rules may be applied to the date fields shown in 300. A first date mapping rule may generate a correct date mapping by interpreting the first number of the date field as the month February. A second mapping rule may generate an incorrect date mapping by interpreting the middle two digits as the month of the transaction, resulting in mappings that indicate transactions occurring in the seventeenth, nineteenth, and twenty-fourth months of the year.

Scoring rules for credit card providers may be used to score the candidate mappings produced for the transaction data shown in 300. The correct mappings may receive high scores, and the incorrect mappings may receive lower scores. For example, credit card transaction data for a user typically reflects a single monthly balance payment (positive transaction) and multiple purchases made with the card that increase the balance owed (negative transaction). Applying the incorrect mapping rules may result in an abnormally large proportion of transactions being positive for a credit card, whereas the correct mapping rules may lead to an expected proportion of transactions being positive. The mapping that results in a high proportion of negative transactions compared to a low, non-zero, proportion of negative transactions may be given a high score by a credit card provider scoring rule. Mapping rules that result in mappings with a high proportion of positive transactions compared to negative transactions and/or mapping rules that result in zero positive transactions or zero negative transactions may result in lower scores than the mapping rules that result in mappings with a higher proportion of negative transactions compared to a low, non-zero, proportion of negative transactions. The mapping rules that resulted in the high scores may be chosen for categorizing transactions involving the credit card provider. Thus, subsequent transactions involving users and the credit card provider may be categorized according to the mapping rules that produced the correct mappings.

Transaction data 310 illustrates an example involving transaction data for transactions involving a service provider and four customers. This transaction data may be illustrative of a random sampling of data involving the bank that is used to generate candidate mappings for the service provider. Transactions involving service providers typically involve clients making payments to the service provider, with rare exceptions such as when the service provider reimburses the client. Here, the transaction data indicates that customers make monthly payments, and that the service provider offers a twelve dollar and twenty-five cent monthly subscription as well as a nine dollar and ninety-nine cent monthly subscription. Each transaction in this data set involves users making payments to the service provider, except one transaction where user 24680 was reimbursed two dollars and twenty-six cents for being accidentally charged for the wrong subscription.

For the data shown in 310, a mapping rule that negates the amount value based on the presence of the word “credit” in an amount field will result in an incorrect mapping and a low score. This is because the service provider uses the word debit to denote transactions where money is transferred to the service provider from the client. Thus, in example 310, debit transactions are negative relative to the client (i.e., the client owes more money after a “debit” transaction) and credit transactions are positive relative to the client (i.e., the client owes less money after a “credit” transaction). Thus, a mapping rule that negates the amount value based on the presence of the word “debit” in an amount field may result in a correct mapping and a high score. This mapping rule may be chosen for mapping transactions involving the service provider.

For the data shown in transaction data 310, a mapping rule that requires interpreting the first set of digits in a date field as the month in which the transaction occurred may receive a low score since, for example, this mapping rule would result in mappings involving a twenty-eighth month of the year (e.g., because a scoring rule may assign higher scores to mappings that result in numerical months between one and twelve than to mappings that result in numerical months outside of the range of one to twelve). In some embodiments, a scoring rule may assign a score of zero to mappings that produce illogical results such as numerical months outside of the range of one to twelve. A mapping rule that interprets the first set of digits in a date field as the day of the month in which the transaction occurred and interprets the second set of digits in a date field as the month in which the transaction occurred may receive a high score. Also, a mapping rule that requires concatenating “20” to the beginning of the last set of digits in the date field may result in a high score compared to other mapping rules, since concatenating “20” to the last set of digits will result in the year being interpreted as 2023 instead of 23 A.D. The mapping rules that caused the highest score(s) (e.g., on average, in aggregate, and/or otherwise) for the transaction data shown in transaction data 310 may be chosen for mapping transactions involving the service provider.

### Example Operations Related to Automated Transaction Categorization

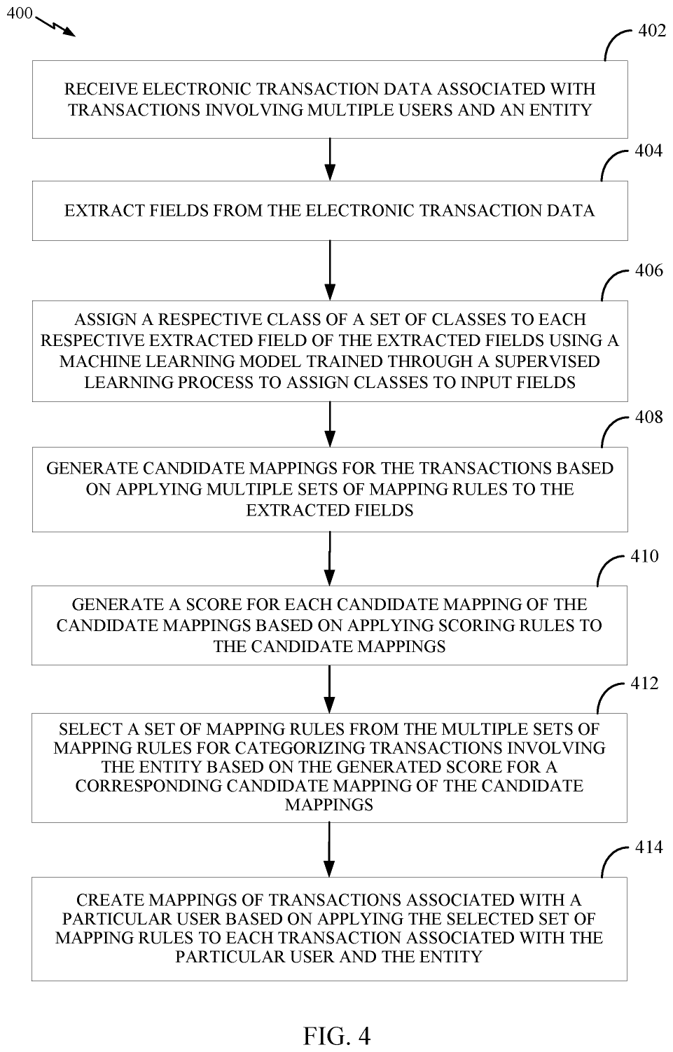

FIG. 4 depicts example operations 400 related to automated transaction categorization. For example, operations 400 may be performed by one or more of the components described in FIG. 1.

Operations 400 begin at step 402 with receiving electronic transaction data associated with transactions involving multiple users and an entity.

Operations 400 continue at step 404 with extracting fields from the electronic transaction data.

Operations 400 continue at step 406 with assigning a respective class of a set of classes to each respective extracted field of the extracted fields using a machine learning model trained through a supervised learning process to assign classes to input fields. Certain embodiments provide that the set of classes includes one or more of a date class, an amount class, or a description class.

Operations 400 continue at step 408 with generating candidate mappings for the transactions based on applying multiple sets of mapping rules to the extracted fields. In some embodiments, information within a field assigned to the amount class comprises an indication that a given transaction involved making a withdrawal from an account associated with a given user. Some embodiments provide that a mapping rule of the set of mapping rules involves negating a value associated with the field assigned to the amount class based on the indication.

Operations 400 continue at step 410 with generating a score for each candidate mapping of the candidate mappings based on applying scoring rules to the candidate mappings. Certain embodiments provide that the scoring rules are chosen for use in generating the score for each candidate mapping of the candidate mappings based on a type corresponding to the entity. In some embodiments, the scoring rules involve scoring transactions associated with the entity based on how many transactions associated with the entity include an amount that is below a threshold amount.

Operations 400 continue at step 412 with selecting a set of mapping rules from the multiple sets of mapping rules for categorizing transactions involving the entity based on the generated score for a corresponding candidate mapping of the candidate mappings.

Operations 400 continue at step 414 with creating mappings of transactions associated with a particular user based on applying the selected set of mapping rules to each transaction associated with the particular user and the entity. According to some embodiments, the mappings of transactions associated with the particular user are scored using the scoring rules.

In certain embodiments, if a threshold number of scores for respective mappings of respective transactions associated with the entity and a plurality of different users determined using the selected set of mapping rules do not exceed a score threshold, a different set of mapping rules are selected from the multiple sets of mapping rules for categorizing transactions involving the entity.

### Example of a Processing System for Automated Transaction Categorization

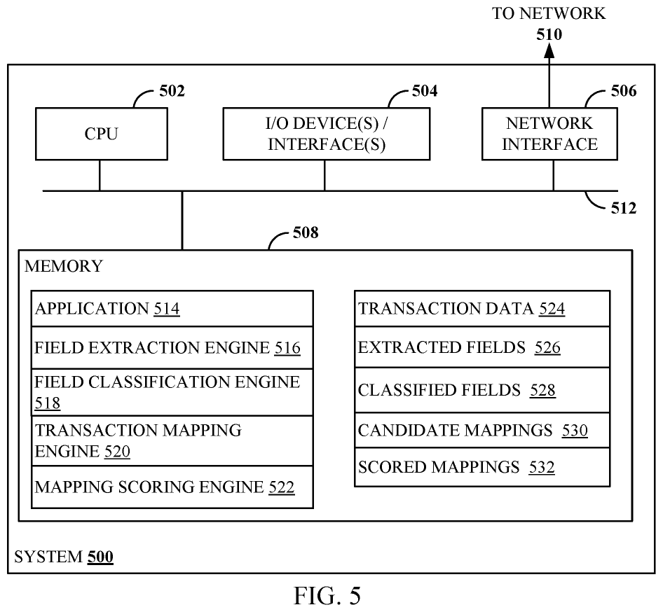

FIG. 5 illustrates an example system 500 with which embodiments of the present disclosure may be implemented. For example, system 500 may be configured to perform operations 400 of FIG. 4 and/or to implement one or more components as in FIG. 1.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes application 514, field extraction engine 516, field classification engine 518, transaction mapping engine 520, and mapping scoring engine 522. Application 514 may be representative of an application used for processing user transactions. In some embodiments, field extraction engine 516 may be representative of field extraction engine 110 of FIG. 1 and FIG. 2. Field classification engine 518 may be representative of field classification engine 120 of FIG. 1 and FIG. 2. Transaction mapping engine 520 may be representative of transaction mapping engine 130 of FIG. 1 and FIG. 2. Mapping scoring engine 522 may be representative of mapping scoring engine 140 of FIG. 1 and FIG. 2.

Memory 508 further comprises transaction data 524, which may correspond to data associated with user transactions. Memory 508 further comprises extracted fields 526 which may correspond to fields extracted by field extraction engine 110 of FIG. 1 and FIG. 2. Memory 508 further comprises classified fields 528, which may include extracted fields that have been classified by field classification engine 120 of FIG. 1 and FIG. 2. Memory 508 further comprises candidate mappings 530, which may correspond to classified fields that have been mapped by transaction mapping engine 130 of FIG. 1 and FIG. 2. Memory 508 further comprises scored mappings 532, which may correspond to candidate mappings and other mappings that have been scored by mapping scoring engine 140 of FIG. 1 and FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automated transaction categorization, comprising:
receiving electronic transaction data associated with transactions involving multiple users and an entity;
extracting fields from the electronic transaction data;
assigning a respective class of a set of classes to each respective extracted field of the extracted fields using a machine learning model trained through a supervised learning process to assign classes to input fields;
generating candidate mappings for the transactions based on applying multiple sets of mapping rules to the extracted fields;
generating a score for each candidate mapping of the candidate mappings based on applying scoring rules to the candidate mappings;
selecting a set of mapping rules from the multiple sets of mapping rules for categorizing transactions involving the entity based on the generated score for a corresponding candidate mapping of the candidate mappings; and
creating mappings of transactions associated with a particular user based on applying the selected set of mapping rules to each transaction associated with the particular user and the entity.

2. The method of claim 1, further comprising using the scoring rules to score the mappings of the transactions associated with the particular user.

3. The method of claim 2, further comprising:
determining that a threshold number of scores for respective mappings of respective transactions associated with the entity and a plurality of different users determined using the selected set of mapping rules do not exceed a score threshold; and
selecting a different set of mapping rules from the multiple sets of mapping rules for categorizing transactions involving the entity based on the determining that the threshold number of scores for the respective mappings of the respective transactions associated with the entity and the plurality of different users determined using the selected set of mapping rules do not exceed the score threshold.

4. The method of claim 1, wherein the set of classes includes one or more of a date class, an amount class, or a description class.

5. The method of claim 4, wherein information within a field assigned to the amount class comprises an indication that a given transaction involved making a withdrawal from an account associated with a given user.

6. The method of claim 5, wherein a mapping rule of the set of mapping rules involves negating a value associated with the field assigned to the amount class based on the indication.

7. The method of claim 1, wherein the scoring rules are chosen for use in generating the score for each candidate mapping of the candidate mappings based on a type corresponding to the entity.

8. The method of claim 7, wherein the scoring rules involve scoring transactions associated with the entity based on how many transactions associated with the entity include an amount that is below a threshold amount.

9. A system for automated transaction categorization, comprising:
one or more processors; and
a memory comprising instructions that, when executed by the one or more processors, cause the system to:
receive electronic transaction data associated with transactions involving multiple users and an entity;
extract fields from the electronic transaction data;
assign a respective class of a set of classes to each respective extracted field of the extracted fields using a machine learning model trained through a supervised learning process to assign classes to input fields;
generate candidate mappings for the transactions based on applying multiple sets of mapping rules to the extracted fields;
generate a score for each candidate mapping of the candidate mappings based on applying scoring rules to the candidate mappings;
select a set of mapping rules from the multiple sets of mapping rules for categorizing transactions involving the entity based on the generated score for a corresponding candidate mapping of the candidate mappings; and
create mappings of transactions associated with a particular user based on applying the selected set of mapping rules to each transaction associated with the particular user and the entity.

10. The system of claim 9, wherein the scoring rules are used to score the mappings of the transactions associated with the particular user.

11. The system of claim 10, wherein the instructions further cause the system to:
determine that a threshold number of scores for respective mappings of respective transactions associated with the entity and a plurality of different users determined using the selected set of mapping rules do not exceed a score threshold; and
select a different set of mapping rules from the multiple sets of mapping rules for categorizing transactions involving the entity based on the determining that the threshold number of scores for the respective mappings of the respective transactions associated with the entity and the plurality of different users determined using the selected set of mapping rules do not exceed the score threshold.

12. The system of claim 9, wherein the set of classes includes one or more of a date class, an amount class, or a description class.

13. The system of claim 12, wherein information within a field assigned to the amount class comprises an indication that a given transaction involved making a withdrawal from an account associated with a given user.

14. The system of claim 13, wherein a mapping rule of the set of mapping rules involves negating a value associated with the field assigned to the amount class based on the indication.

15. The system of claim 9, wherein the scoring rules are chosen for use in generating the score for each candidate mapping of the candidate mappings based on a type corresponding to the entity.

16. The system of claim 15, wherein the scoring rules involve scoring transactions associated with the entity based on how many transactions associated with the entity include an amount that is below a threshold amount.

17. A non-transitory computer readable medium comprising instructions that, when executed by one or more processors of a computing system, cause the computing system to:
receive electronic transaction data associated with transactions involving multiple users and an entity;
extract fields from the electronic transaction data;
assign a respective class of a set of classes to each respective extracted field of the extracted fields using a machine learning model trained through a supervised learning process to assign classes to input fields;
generate candidate mappings for the transactions based on applying multiple sets of mapping rules to the extracted fields;
generate a score for each candidate mapping of the candidate mappings based on applying scoring rules to the candidate mappings;
select a set of mapping rules from the multiple sets of mapping rules for categorizing transactions involving the entity based on the generated score for a corresponding candidate mapping of the candidate mappings; and
create mappings of transactions associated with a particular user based on applying the selected set of mapping rules to each transaction associated with the particular user and the entity.

18. The non-transitory computer readable medium of claim 17, wherein the scoring rules are used to score the mappings of the transactions associated with the particular user.

19. The non-transitory computer readable medium of claim 18, wherein the instructions further cause the computing system to:
determine that a threshold number of scores for respective mappings of respective transactions associated with the entity and a plurality of different users determined using the selected set of mapping rules do not exceed a score threshold; and
select a different set of mapping rules from the multiple sets of mapping rules for categorizing transactions involving the entity based on the determining that the threshold number of scores for the respective mappings of the respective transactions associated with the entity and the plurality of different users determined using the selected set of mapping rules do not exceed the score threshold.

20. The non-transitory computer readable medium of claim 17. wherein the scoring rules are chosen for use in generating the score for each candidate mapping of the candidate mappings based on a type corresponding to the entity.
